(19) United States
(12) Patent Application Publication
(10) Pub. No.: US 2022/0014854 A1
(43) Pub. Date: Jan. 13, 2022

(54) DISPLAY DEVICE

(71) Applicant: WUHAN CHINA STAR OPTOELECTRONICS TECHNOLOGY CO., LTD., Wuhan, Hubei (CN)

(72) Inventor: Yongxiang Zhou, Wuhan, Hubei (CN)

(21) Appl. No.: 16/623,714

(22) PCT Filed: Aug. 19, 2019
(86) PCT No.: PCT/CN2019/101349

§ 371 Date: Sep. 24, 2021

(30) Foreign Application Priority Data
May 27, 2019 (CN) 201910447910.7

(51) Int. Cl. H04R 17/00; H04R 1/28; H04R 1/02

(52) U.S. Cl. CPC H04R 17/005; H04R 2499/15; H04R 1/028; H04R 1/288

(57) ABSTRACT

A display device is disclosed. The display device includes a display panel, a vibration plate, and an actuator structural layer. The vibration plate is attached to a side of the display panel. The actuator structural layer is disposed on the vibration plate.

### BACKGROUND OF INVENTION

### 1. Field of Invention

The present invention relates to a technical field of displays, and particularly to, a display device.

### 2. Related Art

Smart terminals, such as mobile phones and tablets are becoming an indispensable part of our daily lives because they have characteristics of convenience, entertainment, and multi-functions all together. However, with ever-changing display technology, people's lives are greatly enriched by smart terminals developed with more and more cutting-edge technology. But, at the same time, people have stricter requirements and higher expectations for the smart terminals. At the time of enjoying basic functions served by the smart terminals, such as mobile phones and tablets, people have a stricter requirement of the smart terminals such as a full-screen design of smart terminals.

Full-screen technology is a broad definition of industry's design for ultra-high screen ratio mobile phones, and is literally defined that front faces of mobile phones are all screen. Specifically, mobile phones are configured with display areas completely covered with screens, and four edges of frames are designed to be no borders in order to fulfill an ultra-high screen ratio close to 100%. However, limited by basic functions that are indispensable to other mobile phones such as front cameras, earpieces, distance sensors, and light sensors, mobile display devices need to remain certain gaps on top of screens to place the above functional components. As a result, a full-screen display claimed by industries is only referred to as a display with a super high screen ratio for the time being, and there is no display achieving a screen ratio of 100%, that is, a so-called “bangs type screen” or “water drop type screen”, affecting an overall aesthetics of smart terminals. In order to remove handsets on top, screen sound technology has been developed accordingly.

In current screen sound technology, piezoelectric ceramic unit actuators have attracted extensive attention and research due to characteristics of simple structure, easy manufacture, high precision, and low energy consumption. But there are still many problems in current piezoelectric ceramic sound technology because it is not a mature enough technology. For example, current piezoelectric ceramics are quite poor in low-frequency performance, and are easy to cause sound leakage because of poor sound directivity, so privacy cannot be effectively guaranteed.

### SUMMARY OF INVENTION

An object of the present invention is to provide a display device to overcome a problem that conventional piezoelectric ceramics are quite poor in low-frequency performance in under-screen sound technology, and are easy to cause sound leakage because of poor sound directivity.

To achieve the above-mentioned object, the present invention provides a display device comprising a display panel; a vibration plate attached to a side of the display panel; and an actuator structural layer disposed on the vibration plate.

Further, the actuator structural layer comprises a soundproof layer disposed on a surface of the vibration plate far away from the display panel, wherein the soundproof layer comprises a plurality of soundproof strips disposed in an enclosure arrangement, so that at least a soundproof cell is disposed among the soundproof strips; and at least a vibrator correspondingly disposed in the soundproof cell of the soundproof layer.

Further, the vibrator comprises at least an electrode layer and at least a piezoelectric layer, wherein the electrode layer and the piezoelectric layer are alternately disposed in an overlapping arrangement.

Further, the piezoelectric layer is made of one of lead zirconate titanate, aluminum nitride, polyvinylidene fluoride, and polyvinylidene fluoride-trifluoroethylene copolymer.

Further, the soundproof layer has a height of between 1 millimeter (mm) and 200 mm and a width of between 1 mm and 100 mm, wherein the vibrator has a height less than that of the soundproof layer.

Further, the soundproof strips are rectangular, wave-like, zigzag, or arc in shape.

Further, the soundproof cell has three sides each configured with one of the soundproof strips, so that the soundproof cell enclosed by the soundproof strips has a U shape.

Further, the display device further comprises an adhesive layer disposed between the vibration plate and the display panel.

Further, the display panel is a liquid crystal display panel or an organic electroluminescence display panel.

Further, the display device further comprises a main board disposed on a surface of the actuator structural layer far away from the vibration plate; a middle frame disposed on edges of both the main board and the display device, wherein a gap is disposed among the middle frame and the actuator structural layer and the vibration plate; and a buffer layer disposed between the middle frame and the display panel.

The present invention has advantages as follows: the display device of the present invention utilizes a plurality of vibrators under a division of labor to work for vibration of high sounds and bass sounds, so that stereo sound output by screen vibration can be realized. Furthermore, effects of vibration of the vibrators are enlarged by the vibration plate, thereby to improve effects of the display panel in a low-frequency state. In this manner, sound directivity can be improved by disposing the U-shaped soundproof layer to avoid sound leakage and improve user privacy, thereby reducing sound volume loss, and increasing sound volume to be output. The soundproof layer further includes a plurality of soundproof strips being irregular in shape, thereby eliminating standing waves and improving sound quality and user experience. In the display device of the present embodiment, a conventional earpiece device is left out, so a screen ratio of a panel is increased.

### BRIEF DESCRIPTION OF DRAWINGS

To describe the technical solutions in the embodiments of the present invention, the following briefly introduces the accompanying drawings for describing the embodiments. Apparently, the accompanying drawings in the following description show merely some embodiments of the present invention, and a person skilled in the art may still derive other drawings from these accompanying drawings without creative efforts.

FIG. 1 is a schematic structural view showing layers of a display device of a first embodiment to a third embodiment of the present invention.

FIG. 2 is a schematic structural view showing layers of a vibrator of the first embodiment to the third embodiment of the present invention.

FIG. 3 is a schematic layout view of an actuator structural layer of the first embodiment of the present invention.

FIG. 4 is a schematic layout view of an actuator structural layer of the second embodiment of the present invention.

FIG. 5 is a schematic layout view of an actuator structural layer of the third embodiment of the present invention.

### DESCRIPTION OF PREFERRED EMBODIMENTS

The preferred embodiments of the present invention will be described with reference to the accompanying drawings, which are to be construed as illustrative embodiments of the invention. The present invention can be embodied in many different forms of the embodiments of the invention, and the scope of the invention is not limited to the embodiments described herein.

In the drawings, structurally identical components are denoted by the same reference numerals, and structurally or functionally similar components are denoted by like reference numerals. The dimensions and thickness of each component shown in the drawings are arbitrarily shown, and the invention does not limit the size and thickness of each component. In order to make the illustration clearer, some parts of the drawing appropriately exaggerate the thickness of the parts.

The following embodiments are referring to the accompanying drawings for exemplifying specific implementable embodiments of the present invention. Directional terms described by the present invention, such as “upper”, “lower”, “front”, “back”, “left”, “right”, “inner”, “outer”, “side” and etc., are only directions by referring to the accompanying drawings, and thus the used directional terms are used to describe and understanding the present invention, but the present invention is not limited thereto. Moreover, the terms “first”, “second”, “third”, and the like are used for descriptive purposes only and are not to be construed as indicating or implying relative importance.

When a component is described as being “on” another component, the component can be placed directly on the other component. Alternatively, it can also be that the component is placed on an intermediate component. The intermediate member is further placed on the other member. When a component is described as being “mounted to” or “connected to” another component, it can be understood as “directly” or “connected”. Alternatively, a component may be “mounted to” or “connected” to another component through an intermediate component.

### Embodiment 1

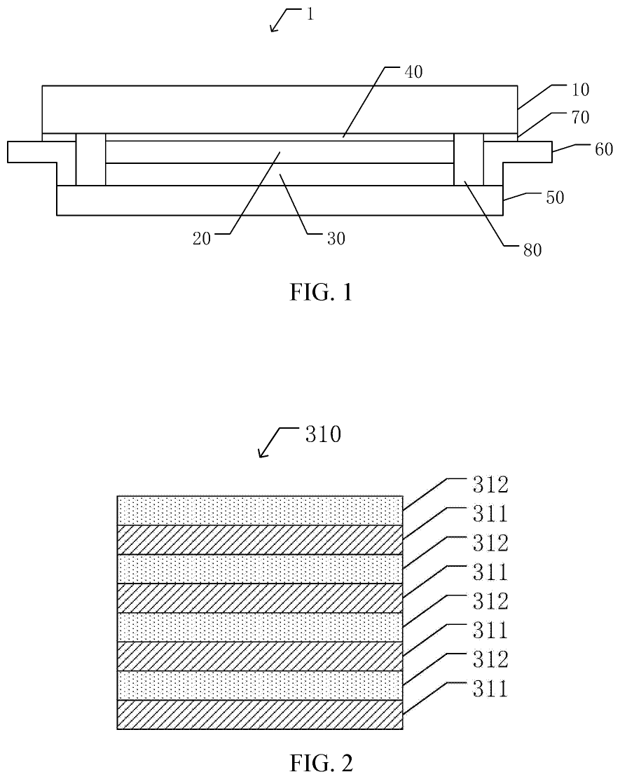

The present application provides a display device 1. As shown in FIG. 1, the display device 1 includes a display panel 10, a vibration plate 20, and an actuator structural layer 30. The vibration plate 20 is attached to a side of the display panel 10. The actuator structural layer 30 is disposed on the vibration plate 20.

The actuator structural layer 30 includes a vibrator 310 and a soundproof layer 320. As shown in FIG. 2, the vibrator 310 is embodied by a multilayer piezoelectric ceramic wafer, including an electrode layer 311 and a piezoelectric layer 312. The electrode layer 311 and the piezoelectric layer 312 are alternately disposed in an overlapping arrangement. The piezoelectric layer 312 is made of one of lead zirconate titanate (PZT), aluminum nitride (AlN), polyvinylidene fluoride (PVDF), and polyvinylidene fluoride-trifluoroethylene copolymer (P(VDF-TrFE)). When an alternating voltage is applied to the electrode layer 311, the piezoelectric layer 312 vibrates, so that sound is transmitted outward. When the vibrator 310 vibrates, the vibration plate 20 will amplify the vibration of the vibrator 310 and transmit the vibration to the display panel 10 enabling the vibration of the display panel 10, thereby transmitting the sound to a user's ear.

As shown in FIG. 3, the soundproof layer 320 is disposed on a surface of the vibration plate 20 far away from the display panel 10. The soundproof layer 320 includes a plurality of soundproof strips disposed in an enclosure arrangement, so that a plurality of U-shaped soundproof cells are disposed among the soundproof strips, and sound waves are transmitted from upper openings of the soundproof cells. In this embodiment of the present invention, the soundproof strips are disposed in the enclosure arrangement to form the soundproof cells in number of three. Each of the soundproof cells encloses one vibrator 310, and two other vibrators 310 located in the leftmost and rightmost soundproof cells in FIG. 3 are high-pitched vibrators 310 for generating high-pitched sounds. The vibrator 310 in a middle of the soundproof units is a bass vibrator 310 for generating bass sounds. In such a configuration, a problem of poor low-frequency performance in a conventional single piece piezoelectric vibrator 310 can be overcome.

In the embodiment of the present invention, soundproof performance and sound volume can be varied by adjusting height and width of the soundproof strips of the soundproof layer 320. First, height of the soundproof strips in an uncompressed state is greater than that of the vibrator 310, thereby achieving good sealing performance. The greater the height of the soundproof strips is, the greater the degree of compression of the soundproof strips is, thereby achieving better sealing performance. But, when a height is too large, it will affect output of the sound volume, so that the output sound volume is less. When width of the soundproof strips is greater, a range of vibration is smaller, and thus soundproof performance is better, but the output sound volume is lesser. Generally, each of the soundproof strips has a height of between 1 mm and 200 mm and a width of between 1 mm and 100 mm Best height and width parameters can be determined based on desired sound quality and volume.

In the embodiment of the present invention, the soundproof strips are rectangular and zigzag in shape. A soundproof strip 321, a soundproof strip 324, and a soundproof strip 325 are rectangular in shape, and are used to prevent sound leakage from being caused by sound waves transmitted to outside in a side or a bottom direction, thereby reducing sound volume loss and increasing sound volume. Furthermore, a soundproof strip 322 and a soundproof strip 323 are zigzag in shape. Since sound waves are reflected when encountering a rectangular soundproof strip and thus form standing waves with other sound waves, frequency and sound pressure of sound output are affected. As a result, the soundproof strip 322 and the soundproof strip 323 are formed to be zigzag in shape to avoid causing standing waves and to eliminate mutual sound interference concurrently, thereby realizing stereo sound and improving sound quality and user experience.

As shown in FIG. 1, the display device 1 further includes an adhesive layer 40, a main board 50, a middle frame 60, and a buffer layer 70.

The adhesive layer 40 is disposed between the display panel 10 and the vibration plate 20 for adhering the vibration plate 20 to the display panel 10.

The main board 50 is disposed on a surface of the actuator structural layer 30 far away from the vibration plate 20. The middle frame 60 is disposed on edges of both the main board 50 and the display device 1, wherein a gap 80 is disposed among the middle frame 60 and the actuator structural layer 30 and the vibration plate 20. The middle frame 60 is configured to protect and support components in the display device 1. The gap 80 is formed to prevent the middle frame 60 from vibrating resulting from a vibration process of the vibrator 310, thereby reducing energy loss and improving user experience. Furthermore, the middle frame 60 in a still state without vibration can also mitigate uncomfortable feelings when toughing a mobile phone, thereby improving user experience. The buffer layer 70 is disposed between the middle frame 60 and the display panel 10. The buffer layer 70 is configured to protect the display panel 10 from being damaged by a possible impact from the middle frame 60 during the vibration process. The buffer layer 70 may be made of an elastic material, such as foam, brewing plastic, or rubber.

In the embodiment of the present invention, there are three vibrators 310 provided in the display device 1. The three vibrators 310 are responsible for vibration of high and bass sounds, respectively, so that stereo sound output by screen vibration can be realized. Furthermore, effects of vibration of the vibrators 310 are enlarged by the vibration plate 20, thereby to improve effects of the display panel 10 in a low-frequency state. In this manner, sound directivity can be improved by disposing the soundproof layer 320 to avoid sound leakage and improve user privacy, thereby reducing sound volume loss, and increasing sound volume to be output. The soundproof layer 320 further includes a plurality of soundproof strips being wave-like in shape, thereby eliminating standing waves and improving sound quality and user experience. In the display device 1 of the present embodiment, a conventional earpiece device is left out, so a screen ratio of a panel is increased.

### Embodiment 2

The present application provides a display device 1. As shown in FIG. 1, the display device 1 includes a display panel 10, a vibration plate 20, and an actuator structural layer 30. The vibration plate 20 is attached to a side of the display panel 10. The actuator structural layer 30 is disposed on the vibration plate 20.

The actuator structural layer 30 includes a vibrator 310 and a soundproof layer 320. As shown in FIG. 2, the vibrator 310 is embodied by a multilayer piezoelectric ceramic wafer, including an electrode layer 311 and a piezoelectric layer 312. The electrode layer 311 and the piezoelectric layer 312 are alternately disposed in an overlapping arrangement. The piezoelectric layer 312 is made of one of lead zirconate titanate (PZT), aluminum nitride (AlN), polyvinylidene fluoride (PVDF), and polyvinylidene fluoride-trifluoroethylene copolymer (P(VDF-TrFE)). When an alternating voltage is applied to the electrode layer 311, the piezoelectric layer 312 vibrates, so that sound is transmitted outward. When the vibrator 310 vibrates, the vibration plate 20 will amplify the vibration of the vibrator 310 and transmit the vibration to the display panel 10 enabling the vibration of the display panel 10, thereby transmitting the sound to a user's ear.

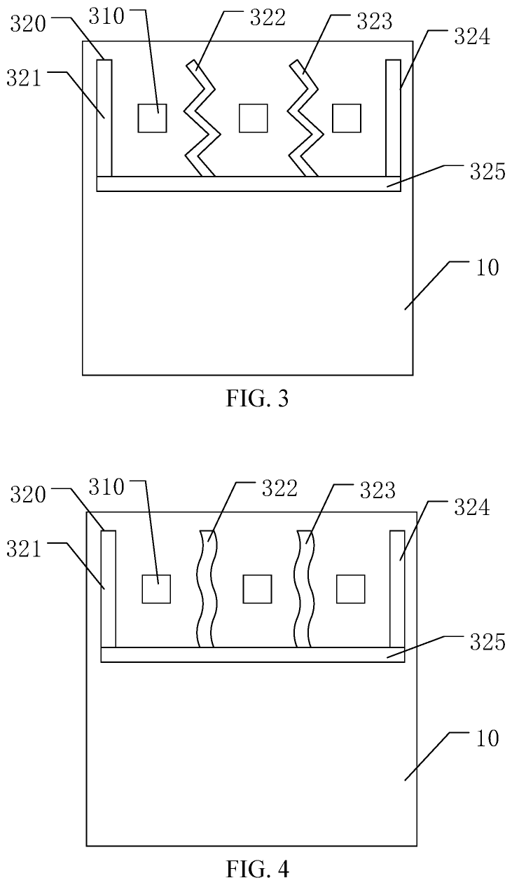

As shown in FIG. 4, the soundproof layer 320 is disposed on a surface of the vibration plate 20 far away from the display panel 10. The soundproof layer 320 includes a plurality of soundproof strips disposed in an enclosure arrangement, so that a plurality of U-shaped soundproof cells are disposed among the soundproof strips, and sound waves are transmitted from upper openings of the soundproof cells. In this embodiment of the present invention, the soundproof strips are disposed in the enclosure arrangement to form the soundproof cells in number of three. Each of the soundproof cells encloses one vibrator 310, and two other vibrators 310 located in the leftmost and rightmost soundproof cells in FIG. 4 are high-pitched vibrators 310 for generating high-pitched sounds. The vibrator 310 in a middle of the soundproof units is a bass vibrator 310 for generating bass sounds. In such a configuration, a problem of poor low-frequency performance in a conventional single piece piezoelectric vibrator 310 can be overcome.

In the embodiment of the present invention, soundproof performance and sound volume can be varied by adjusting height and width of the soundproof strips of the soundproof layer 320. First, height of the soundproof strips in an uncompressed state is greater than that of the vibrator 310, thereby achieving good sealing performance. The greater the height of the soundproof strips is, the greater the degree of compression of the soundproof strips is, thereby achieving better sealing performance. But, when a height is too large, it will affect output of the sound volume, so that the output sound volume is less. When width of the soundproof strips is greater, a range of vibration is smaller, and thus soundproof performance is better, but the output sound volume is lesser. Generally, each of the soundproof strips has a height of between 1 mm and 200 mm and a width of between 1 mm and 100 mm Best height and width parameters can be determined based on desired sound quality and volume.

In the embodiment of the present invention, the soundproof strips are rectangular and wave-like in shape. A soundproof strip 321, a soundproof strip 324, and a soundproof strip 325 are rectangular in shape, and are used to prevent sound leakage from being caused by sound waves transmitted to outside in a side or a bottom direction, thereby reducing sound volume loss and increasing sound volume. Furthermore, a soundproof strip 322 and a soundproof strip 323 are wave-like in shape. Since sound waves are reflected when encountering a rectangular soundproof strip and thus form standing waves with other sound waves, frequency and sound pressure of sound output are affected. As a result, the soundproof strip 322 and the soundproof strip 323 are formed to be wave-like in shape to avoid causing standing waves and to eliminate mutual sound interference concurrently, thereby realizing stereo sound and improving sound quality and user experience.

As shown in FIG. 1, the display device 1 further includes an adhesive layer 40, a main board 50, a middle frame 60, and a buffer layer 70.

The adhesive layer 40 is disposed between the display panel 10 and the vibration plate 20 for adhering the vibration plate 20 to the display panel 10.

The main board 50 is disposed on a surface of the actuator structural layer 30 far away from the vibration plate 20. The middle frame 60 is disposed on edges of both the main board 50 and the display device 1, wherein a gap 80 is disposed among the middle frame 60 and the actuator structural layer 30 and the vibration plate 20. The middle frame 60 is configured to protect and support components in the display device 1. The gap 80 is formed to prevent the middle frame 60 from vibrating resulting from a vibration process of the vibrator 310, thereby reducing energy loss and improving user experience. Furthermore, the middle frame 60 in a still state without vibration can also mitigate uncomfortable feelings when toughing a mobile phone, thereby improving user experience. The buffer layer 70 is disposed between the middle frame 60 and the display panel 10. The buffer layer 70 is configured to protect the display panel 10 from being damaged by a possible impact from the middle frame 60 during the vibration process. The buffer layer 70 may be made of an elastic material, such as foam, brewing plastic, or rubber.

In the embodiment of the present invention, there are three vibrators 310 provided in the display device 1. The three vibrators 310 are responsible for vibration of high and bass sounds, respectively, so that stereo sound output by screen vibration can be realized. Furthermore, effects of vibration of the vibrators 310 are enlarged by the vibration plate 20, thereby to improve effects of the display panel 10 in a low-frequency state. In this manner, sound directivity can be improved by disposing the U-shaped soundproof layer 320 to avoid sound leakage and improve user privacy, thereby reducing sound volume loss, and increasing sound volume to be output. The soundproof layer 320 further includes a plurality of soundproof strips being wave-like in shape, thereby eliminating standing waves and improving sound quality and user experience. In the display device 1 of the present embodiment, a conventional earpiece device is left out, so a screen ratio of a panel is increased.

### Embodiment 3

The present application provides a display device 1. As shown in FIG. 1, the display device 1 includes a display panel 10, a vibration plate 20, and an actuator structural layer 30. The vibration plate 20 is attached to a side of the display panel 10. The actuator structural layer 30 is disposed on the vibration plate 20.

The actuator structural layer 30 includes a vibrator 310 and a soundproof layer 320. As shown in FIG. 2, the vibrator 310 is embodied by a multilayer piezoelectric ceramic wafer, including an electrode layer 311 and a piezoelectric layer 312. The electrode layer 311 and the piezoelectric layer 312 are alternately disposed in an overlapping arrangement. The piezoelectric layer 312 is made of one of lead zirconate titanate (PZT), aluminum nitride (AlN), polyvinylidene fluoride (PVDF), and polyvinylidene fluoride-trifluoroethylene copolymer (P(VDF-TrFE)). When an alternating voltage is applied to the electrode layer 311, the piezoelectric layer 312 vibrates, so that sound is transmitted outward. When the vibrator 310 vibrates, the vibration plate 20 will amplify the vibration of the vibrator 310 and transmit the vibration to the display panel 10 enabling the vibration of the display panel 10, thereby transmitting the sound to a user's ear.

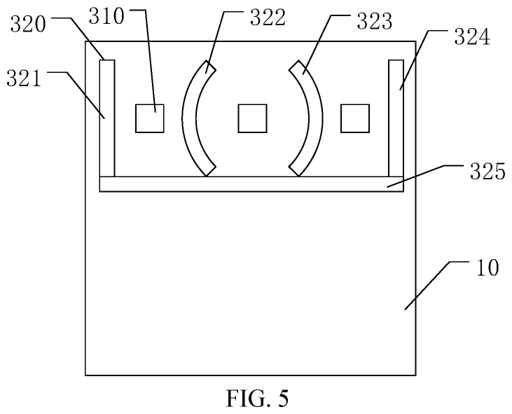

As shown in FIG. 5, the soundproof layer 320 is disposed on a surface of the vibration plate 20 far away from the display panel 10. The soundproof layer 320 includes a plurality of soundproof strips disposed in an enclosure arrangement, so that a plurality of U-shaped soundproof cells are disposed among the soundproof strips, and sound waves are transmitted from upper openings of the soundproof cells. In this embodiment of the present invention, the soundproof strips are disposed in the enclosure arrangement to form the soundproof cells in number of three. Each of the soundproof cells encloses one vibrator 310, and two other vibrators 310 located in the leftmost and rightmost soundproof cells in FIG. 5 are high-pitched vibrators 310 for generating high-pitched sounds. The vibrator 310 in a middle of the soundproof units is a bass vibrator 310 for generating bass sounds. In such a configuration, a problem of poor low-frequency performance in a conventional single piece piezoelectric vibrator 310 can be overcome.

In the embodiment of the present invention, soundproof performance and sound volume can be varied by adjusting height and width of the soundproof strips of the soundproof layer 320. First, height of the soundproof strips in an uncompressed state is greater than that of the vibrator 310, thereby achieving good sealing performance. The greater the height of the soundproof strips is, the greater the degree of compression of the soundproof strips is, thereby achieving better sealing performance. But, when a height is too large, it will affect output of the sound volume, so that the output sound volume is less. When width of the soundproof strips is greater, a range of vibration is smaller, and thus soundproof performance is better, but the output sound volume is lesser. Generally, each of the soundproof strips has a height of between 1 mm and 200 mm and a width of between 1 mm and 100 mm Best height and width parameters can be determined based on desired sound quality and volume.

In the embodiment of the present invention, the soundproof strips are rectangular and arc in shape. A soundproof strip 321, a soundproof strip 324, and a soundproof strip 325 are rectangular in shape, and are used to prevent sound leakage from being caused by sound waves transmitted to outside in a side or a bottom direction, thereby reducing sound volume loss and increasing sound volume. Furthermore, a soundproof strip 322 and a soundproof strip 323 are arc in shape. Since sound waves are reflected when encountering a rectangular soundproof strip and thus form standing waves with other sound waves, frequency and sound pressure of sound output are affected. As a result, the soundproof strip 322 and the soundproof strip 323 are formed to be arc in shape to avoid causing standing waves and to eliminate mutual sound interference concurrently, thereby realizing stereo sound and improving sound quality and user experience.

As shown in FIG. 1, the display device 1 further includes an adhesive layer 40, a main board 50, a middle frame 60, and a buffer layer 70.

The adhesive layer 40 is disposed between the display panel 10 and the vibration plate 20 for adhering the vibration plate 20 to the display panel 10.

The main board 50 is disposed on a surface of the actuator structural layer 30 far away from the vibration plate 20. The middle frame 60 is disposed on edges of both the main board 50 and the display device 1, wherein a gap 80 is disposed among the middle frame 60 and the actuator structural layer 30 and the vibration plate 20. The middle frame 60 is configured to protect and support components in the display device 1. The gap 80 is formed to prevent the middle frame 60 from vibrating resulting from a vibration process of the vibrator 310, thereby reducing energy loss and improving user experience. Furthermore, the middle frame 60 in a still state without vibration can also mitigate uncomfortable feelings when toughing a mobile phone, thereby improving user experience. The buffer layer 70 is disposed between the middle frame 60 and the display panel 10. The buffer layer 70 is configured to protect the display panel 10 from being damaged by a possible impact from the middle frame 60 during the vibration process. The buffer layer 70 may be made of an elastic material, such as foam, brewing plastic, or rubber.

In the embodiment of the present invention, there are three vibrators 310 provided in the display device 1. The three vibrators 310 are responsible for vibration of high and bass sounds, respectively, so that stereo sound output by screen vibration can be realized. Furthermore, effects of vibration of the vibrators 310 are enlarged by the vibration plate 20, thereby to improve effects of the display panel 10 in a low-frequency state. In this manner, sound directivity can be improved by disposing the soundproof layer 320 to avoid sound leakage and improve user privacy, thereby reducing sound volume loss, and increasing sound volume to be output. The soundproof layer 320 further includes a plurality of soundproof strips being wave-like in shape, thereby eliminating standing waves and improving sound quality and user experience. In the display device 1 of the present embodiment, a conventional earpiece device is left out, so a screen ratio of a panel is improved.

Although the present invention has been disclosed as a preferred embodiment, it is not intended to limit the present invention. Those skilled in the art without departing from the spirit and scope of the present invention may make various changes or modifications, and thus the scope of the present invention should be after the appended claims and their equivalents. It should be understood that the different dependent claims and the features described herein may be combined in a manner different from that described in the original claims. It will also be appreciated that features described in connection with separate embodiments may be used in other described embodiments.

What is claimed is:

1. A display device, comprising:
a display panel;
a vibration plate attached to a side of the display panel; and
an actuator structural layer disposed on the vibration plate.

2. The display device of claim 1, wherein the actuator structural layer comprises:
a soundproof layer disposed on a surface of the vibration plate far away from the display panel, wherein the soundproof layer comprises a plurality of soundproof strips disposed in an enclosure arrangement, so that at least a soundproof cell is disposed among the soundproof strips; and
at least a vibrator correspondingly disposed in the soundproof cell of the soundproof layer.

3. The display device of claim 1, wherein the vibrator comprises at least an electrode layer and at least a piezoelectric layer, wherein the electrode layer and the piezoelectric layer are alternately disposed in an overlapping arrangement.

4. The display device of claim 3, wherein the piezoelectric layer is made of one of lead zirconate titanate, aluminum nitride, polyvinylidene fluoride, and polyvinylidene fluoride-trifluoroethylene copolymer.

5. The display device of claim 2, wherein the soundproof layer has a height of between 1 millimeter (mm) and 200 mm and a width of between 1 mm and 100 mm, wherein the vibrator has a height less than that of the soundproof layer.

6. The display device of claim 2, wherein the soundproof strips are rectangular, wave-like, zigzag, or arc in shape.

7. The display device of claim 2, wherein the soundproof cell has three sides each configured with one of the soundproof strips, so that the soundproof cell enclosed by the soundproof strips has a U shape.

8. The display device of claim 1, further comprising:
an adhesive layer disposed between the vibration plate and the display panel.

9. The display device of claim 1, wherein the display panel is a liquid crystal display panel or an organic electroluminescence display panel.

10. The display device of claim 1, further comprising:
a main board disposed on a surface of the actuator structural layer far away from the vibration plate;
a middle frame disposed on edges of both the main board and the display device, wherein a gap is disposed among the middle frame and the actuator structural layer and the vibration plate; and
a buffer layer disposed between the middle frame and the display panel.
